(19) United States
(12) Patent Application Publication
(10) Pub. No.: US 2015/0222504 A1
(43) Pub. Date: Aug. 6, 2015

(54) SYSTEM AND METHOD FOR MONITORING AND REPORTING DATA IN API PROCESSING SYSTEMS

(71) Applicant: Apigee Corporation, San Jose, CA (US)

(72) Inventor: Kumar SRIVASTAVA, San Jose, CA (US)

(73) Assignee: Apigee Corporation, San Jose, CA (US)

(21) Appl. No.: 14/170,657

(22) Filed: Feb. 3, 2014

(51) Int. Cl. H04L 12/26; H04L 29/06

(52) U.S. Cl. CPC H04L 43/045; H04L 67/42; H04L 43/0876

(57) ABSTRACT

A method is provided for monitoring and reporting data of one or more application programmer interface (API) entities. The method includes receiving a request for usage data of one or more API entities. The method further includes monitoring said usage data from at least one server. The method also includes displaying information pertaining to said monitored usage data.

### FIELD OF THE INVENTION

The present invention generally relates API processing systems, and more particularly to monitoring and reporting data in API processing systems.

### BACKGROUND OF THE INVENTION

An Application Program Interface (API) is a programming language format used by an application program to communicate with an operating system or other control programs such as a database management system (DBMS) or communications protocol. An API typically includes a library of components such as routines, protocols and tools for building software applications. The components may be software functions and processes such as executable code or scripts. In the case of “Web APIs”, the APIs may be exposed over a network such as in a web page or desktop application that access API over the Internet. Most operating environments such as Windows, Unix, Linux, or like systems provide API components so that developers can run and execute applications consistent with the operating environment.

APIs allow developers to create application software (i.e. an “app”) which can communicate directly with a particular operating system or computer platform by integrating functions from the operation system's API library into the application software. The term app can refer to mobile applications that utilize APIs. Developers may implement apps in various programming languages using various platforms. Therefore, APIs enable app developers to easily access and reuse application logic built by other developers.

More recently, developers may use a software development kit (SDK or devkit) to build applications and APIs for operating systems and/or platforms. An API Product Diagnostic may be a type of application that runs on a SDK acting as a means for communicating between servers and one more web APIs, generic HTTP services, or applications. Such an API diagnostic can be implemented as a set of configuration files and software code which rely on resources provided by the SDK.

In addition, web based APIs may be provided to developers in order to integrate services between two or more HTTP enabled services. These combined services may be referred to as a “mashup.” For example, Housingmaps.com is a mashup that applies real estate information, such as apartments for rent or homes for sale from craigslist.com to Google Maps. The mashup results in a system that allows the user to sort apartments and homes by price and location onto an interactive map, allowing for efficient browsing of housing options.

One issue with present approaches to gathering and analyzing API information is that there lacks a suitable way to track and report the traffic of entities like APIs, resources, apps, developers and products that flow within an API ecosystem. Tracking and reporting such traffic enables detecting problems such as lower usage trends over time or diminishing contribution from apps and early notification of the entities which contribute to traffic, thereby allowing API providers and developers to take appropriate steps to improve APIs and make better decisions related to API programs. It is therefore desirable to offer a system for monitoring and reporting API traffic in a manner that provides greater visibility and analysis of API performance to API developers and providers.

### SUMMARY OF THE INVENTION

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

According to one embodiment of the present invention a method is provided for monitoring and reporting data of one or more application programmer interface (API) entities. The method includes receiving a request for usage data of one or more API entities. The method further includes monitoring said usage data from at least one server. The method also includes displaying information pertaining to said monitored usage data.

According to another embodiment of the present invention an application program interface (API) analytics system for monitoring and reporting data of one or more application programmer interface (API) entities is provided. The system includes an API diagnostic receiving a request for usage data of one or more API entities. The system further includes a processor monitoring said usage data from at least one server. The system also includes a display unit displaying information pertaining to said monitored usage data.

These and other aspects, objects, and features of the present invention will be understood and appreciated by those skilled in the art upon studying the following specification, claims, and appended drawings.

### BRIEF DESCRIPTION OF THE DRAWINGS

In the drawings:

FIG. 1 illustrates a block diagram of an API analytics system including a diagnostic application that monitors and controls API traffic according to an illustrative embodiment of the invention.

FIG. 2 illustrates a block diagram of the Product Diagnostic according to an illustrative embodiment of the invention.

FIG. 3 illustrates a Graphical User Interface (GUI) displaying API traffic information over a one hour period according to an illustrative embodiment of the invention.

FIG. 4 illustrates a Graphical User Interface (GUI) displaying an expanded detailed view of a plot of API traffic for a time period of ten days according to an illustrative embodiment of the invention. Product Diagnostic

FIG. 5 illustrates a Graphical User Interface (GUI) displaying performance metrics of resource paths in an API Product Diagnostic according to an illustrative embodiment of the invention.

FIG. 6A illustrates a Graphical User Interface (GUI) displaying user added performance metrics of resource paths in an API diagnostic according to an illustrative embodiment of the invention.

FIG. 6B illustrates a Graphical User Interface (GUI) displaying APIs with the highest traffic over a selected time period of time according to an illustrative embodiment of the invention.

FIG. 7A illustrates a Graphical User Interface (GUI) for building a custom report to receive statistics of API traffic based on user preferences according to one embodiment of the present invention.

FIG. 7B illustrates a Graphical User Interface (GUI) displaying a generated custom report of API traffic based on user inputted metrics according to an illustrative embodiment of the invention.

FIG. 7C illustrates a Graphical User Interface (GUI) displaying a generated custom bar graph for a plurality of resource paths based on user inputted metrics according to an illustrative embodiment of the invention.

FIG. 7D illustrates a Graphical User Interface (GUI) displaying a user selected option of exporting a saved custom report to CSV, PDF or PNG format according to an illustrative embodiment of the invention.

FIG. 8 illustrates a GUI 80 displaying a Traffic Composition Report for monitoring the contribution of entities to API traffic with relative traffic contribution displayed via a circle graph according to an illustrative embodiment of the invention.

FIG. 9 illustrates a GUI 90 displaying a Traffic Composition Report for monitoring the contribution of entities to API traffic with relative traffic contribution displayed via a bar graph according to an illustrative embodiment of the invention.

### DETAILED DESCRIPTION

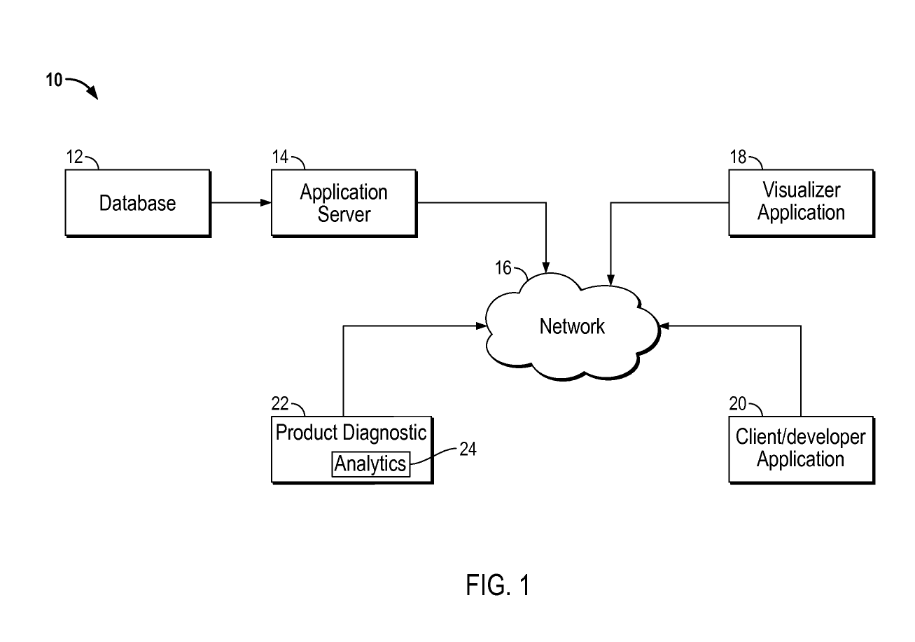

FIG. 1 is a block diagram of an API system 10 including an Apigee® Product Diagnostic 22 that monitors and controls access of “API Entities” according to an illustrative embodiment of the invention. “Entities” may be any elements or actors which are part of the API ecosystem 10 including users, applications, devices, network between devices and the diagnostic, components of the diagnostic API, backend services, and the network between the diagnostic and the backend service, etc. The system 10 includes a database 12 containing API entity information, application server 14, network 16, visualizer application 18, client/developer application 20, and Apigee® diagnostic 22 with analytics monitor/control 24. The system 10 may also include remote developer systems and user controlled devices such as a mouse and keyboard. The visualizer application 18 may include a graphical user interface (GUI) such as a web browser.

In the preferred embodiment, Product Diagnostic 22 may receive requests to access system 10 from developers via a client application 20. Once a request is accepted, the diagnostic 22 may communicate with application server 14 to retrieve requested API information from database 12. The Product Diagnostic 22 may then retrieve requests from client application 20 to server 14 and return responses from server 14 back to the client application 20. Thus, the diagnostic Product Diagnostic 22 may provide the artifice that the client application 20 is communicating directly with a remote server 14. In one embodiment, diagnostic 22 acts as an entryway for developers to access API information from database 12 in analytics system 10. During these communications and subsequent ones between server 14 and client application 20, diagnostic 22 may gather information regarding the traffic of the APIs including usage rates, origins of request (e.g. IP addresses or URL), kinds of API calls, frequency of the API calls, and so forth.

Database 12 may include one or more magnetic disks, tape drives, disk drives or other mass storage for storing data and instructions for use by system 10 in a computer system. At least one component of the database 12, preferably in the form of a disk drive or tape drive, stores the information used for processing the system 10. The database may also include one or more drives for various portable media, such as a floppy disk, a compact disc read only memory (CD-ROM), or an integrated circuit non-volatile memory adapter (i.e. PC-MCIA adapter) to input and output data and code to and from a computer readable media. In one embodiment, the database includes a plurality of storage devices or media that are interconnected via a communications network. The plurality of storage media may interact such that the storage media function as a virtual mass storage system. One or more of the plurality of storage media may reside in separate locations while being interconnected electronically.

The system 10 may allow web systems to make their services available on network 16 so that their services may be consumed by developer apps 20 running on mobile devices and desktops. For example, a service provider may wish to share their services 12 that provide product pricing, availability information, sales and ordering services across system 10. In some embodiments, server 14 and client 20 employ applications employing asynchronous JavaScript+XML (Ajax) and other technologies using asynchronous loading and content presentation techniques, for example SHTML, document object model (DOM), JavaScript. Web based applications may use web protocols including services oriented access protocol (SOAP) and representational state transfer (REST). A service provider may share their services in database 12 as a set of HTTP endpoints in communication with application server 14. Client app developers may then make HTTP requests via Client/developer application 20 to these endpoints. Depending on the endpoint, application server may then return data formatted as XML or JSON back to developer application 20. The client created apps 20 which consume these services can be implemented as standalone applications of mobile devices or tables such as HTML5 applications running in a web browser, or any other type of application that can make a request to the HTTP endpoint and consume response data. Such client applications 20 may be developed and released by the same provider which shares their services 12 on system 10, or by a third party application developer who makes use of publicly available services. Application server 14 may include a server running Web 2.0 application or the like. Connected and in communication with system 10 may be a device capable of running a browser that supports Web 2.0 such as a cell phone, laptop, and the like. Web applications running on server 14 may use server-side dynamic content generation such as CGI, PHP, ASP or Java servlets, for example.

System 10 may act as a service provider, creating and maintain services that developers use to create client apps 20. In a preferred embodiment, system 10 may provide secure access to services with a defined API that is consistent across services, regardless of service implementation. A consistently defined API may allow app developers to consume services, enables changes to a backend service implementation without affecting public API, enables taking advantage of the various analytics 34 built into diagnostic server 22 of system 10.

In addition, diagnostic Product Diagnostic 22 may function as a mapping of publicly available HTTP endpoint to a company's web page backend service (e.g. ESB, SOA, App Servers). Since app developers may make HTTP requests to Product Diagnostic 22, rather than directly to the service provider's services, developers need not know the specifics of implementing such services. The developer may simply need to know the URL of the API Product Diagnostic endpoint, query parameters, heads or body parameters passed in the request, and any required authentication and authorization credentials of system 10. In addition, developer may need to know the HTTP response information including response data format such as XML or JSON. Therefore, diagnostic Product Diagnostic 22 may isolate app developer and developer application 20 from the backend service. This allows service providers to move services to a new host or make any other changes to the service implementation. In addition, diagnostic Product Diagnostic 22 allows for adding increased functionality to the Product Diagnostic 22 without making changes to the backend service. For example, service providers may add policies to the Product Diagnostic 22 to perform data transformations, filtering, added security, execute conditional logic or custom code, and the like.

In another embodiment, system 10 may provide developer services for API creation and development of client applications 20. A service provider may choose to build API proxies using APIs, SDKs and other convenience services as an app developer. Application server 14 may provide the necessary tools for adding and configuring API proxies, setting up API products, and managing developers and client applications 20. Thus, server 14 may off land many common management concerns from backend services.

In some embodiments, when API traffic is detected during exchanges between the application server 14 and client/developer application 20, the diagnostic Product Diagnostic 22 may collect entity information related to these communications to analysis and correct for unexpected changes in traffic. Such corrective actions, which may be automatic or user controlled, may include blocking certain users from access, adding more processing bandwidth, revoking developer keys, rerouting traffic or implementing additional diagnostic changes, and the like. The information diagnostic 22 collects as data passes through includes API call information (URL, IP, and user ID), latency, errors and so forth. The data may be gathered into trend charts and tables throughout an API Platform UI. The user may use this data to monitor the health of the API program and health of individual API.

In some embodiments, the behavior of diagnostic 22 may be customized by applying custom strips and making calls out to a third party API and services. In addition, a cloud-based backend service may be provided on network 16 via client/developer application 20 for powering mobile and web applications. The cloud-based backend service may give developers access to flexible data store and key differentiating features such as social graphs, geolocation, user management, push notifications, and performance monitoring. The cloud-based backend service may be available with SDKs for iOS, Android, JavaScript, and others, thereby allowing developers to create applications without implementing a core backend service and infrastructure.

In some embodiments, visualizer 18 may include internet browser software and the diagnostic Product Diagnostic 22 may be configured as a server capable of interpreting web protocols that may be used by visualizer 18 and client application 20. For example, such protocols may include Hypertext Transfer Protocol (HTTP), File Transfer Protocol (FTP), Telnet, and Secure Sockets Layer (SSL) and so forth.

The foregoing embodiments of system 10 may be realized as a software component operative within an operating system such as, without limitation, Windows or Unix or Linux. In such an embodiment, Product Diagnostic 22 can be implemented in a high level computing language such as C, C++, Fortran, or Java or Visual BASIC. In addition, script based programs may be used such as PHP, WML, and so forth.

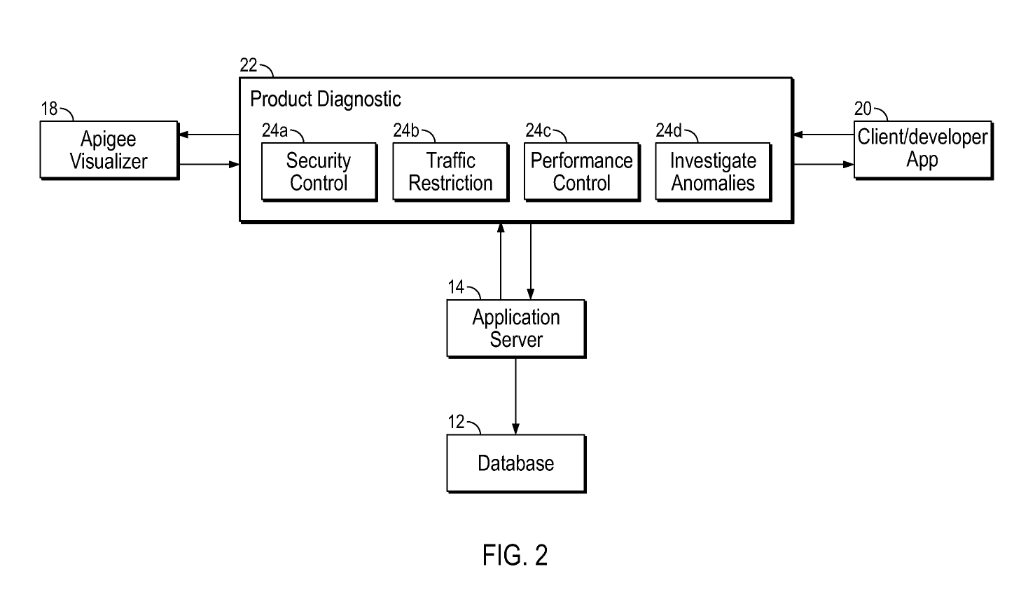

FIG. 2 is a block diagram of the diagnostic Product Diagnostic 22 with analytics components 24 and visualizer 18 according to an illustrative embodiment of the invention. The visualizer application 18 may be a software application running on any one or combination of the application server 14, client application 20 or Product Diagnostic 22 in system 10. The visualizer application 18 may interface with a GUI to enable interaction with a user and may also be executed on a portable computing device such as a laptop, cell phone, PDA or other devices that can communicate remotely with diagnostic 22.

In preferred embodiments, the analytics system 24 in communication with visualizer 18 provides tools to observe short and long term usage trends for API entities in the API Ecosystem 10. As data passes through Product Diagnostic 22, several types of information may be collected such as URL, IP, user ID for API call information, latency, and error data. In addition, developers may create programs called “policies” to add additional information, such as headers, query parameters, portions of a request or response extracted from XML or JSON. Such information may be collected asynchronously from actual request/response flow and therefore has no effect on API performance.

Analytics services 24 may collect and analyze, in real time, several kinds of information that flow through APIs in network 16 such as URL, IP, user ID for API call information, latency, and error data. The data analysis may include determining API traffic trends over time, top developers, when API response time is fastest, geographically where API traffic is highest. Such continuous data analysis may help service providers improve their APIs, troubleshoot problems and make better business decisions with their API program such as how much API traffic capacity may be needed in the future. API data may be sorted using a query parameter as part of a request by client or service provider. The parameter may enable filtering of statistics for a list of API entities that enable a particular condition (e.g. top developer as measured by throughput or worst performers as measured by target API latency). Query parameters may define attributes of chosen dimension used to calculate statistics (metrics), calculations run against the metric defined for the dimension (functions), time intervals over which data should be analyzed (time ranges) and attributes used to simply or sort across results (filters). A client/developer may access metrics via a visualization API which can automate certain analytics functions, such as retrieving metrics periodically using an automation client or script. In addition, the visualization API may be built by the client/developer in the form of custom widgets which can be embedded in portals or custom apps.

In a preferred embodiment, analytics system 24 within Product Diagnostic 22 may perform automatic or user driven corrective actions based on detected API traffic. Analytics unit 24 within Product Diagnostic 22 may provide several units enabled to take the corrective actions via such as a security control unit 24a, traffic restriction unit 24b, performance control unit 24c, and investigation analytics unit.

Security control unit 24a may limit future spikes or drops in traffic by revoking and/or regulating access of developer keys or blocking access of IP addresses detected as causing spikes or drops in API traffic. Security control may involve limiting access of one or more API developer keys or IP addresses to certain API entities or functions. For example, diagnostic application 22 may regulate access to an API due to an identified IP address of API call or geographical location of the API call or header in the call signifying a particular developer. Other entities that may be regulated by security control unit 24a in making access to API information in ecosystem 10 include the client/server application or backend service or format of the data making the API request. In another embodiment, Product Diagnostic 22 may provide enhanced security and encryption. Enhanced security may include cryptographic authentication, message integrity checking, encryption, and other like services. The security may include protocols such as IPSEC and IKE. The encryption may include DES AES, RSA and other public key or private key systems.

Diagnostic 22 may provide a traffic restriction unit 24b. The traffic restriction unit 24b may limit future spikes or drops in traffic by turning off access to APIs from a developer's account once a threshold of API requests from a developer's account has been detected. Such a predetermined threshold may be a number of API calls by an IP address or developer account counted by a counter in system 10 within a predetermined time frame, e.g. 12 hours. Once this predetermined threshold is met, traffic restriction unit 24b may turn off access of API entities by the IP address or developer account. In addition, if the threshold of API calls is met, the traffic restriction unit 24b may limit future access of API entities such as controlling the number of times and API can be accessed by a given developer application 20.

An anomalies analytics unit 24d within the diagnostic Product Diagnostic 22 may regulate API traffic by tracking API access information over a predetermined period of time. For example, the investigation analytics 24d may capture such API information pertaining to entities accessing the API calls such as a tracked backend service, application, app, or client/developer during the traffic irregularity periods. Diagnostic Product Diagnostic 22 may calculate traffic irregularity periods and display traffic patterns before, at and after data irregularities via visualizer 18. The anomalies may be displayed by app, developer, client IP address, or target URL. Analytics unit 24 may also limit future irregularities in API traffic by providing a performance control unit 24c. Once anomalies in traffic are determined, the performance control unit 24c may reroute API access requests via a conditional algorithm for traffic flow or calculate and provide more processing and bandwidth for traffic such as caching. Analytics units 24a-24d may be implemented as an separate application or a routine of diagnostic 22.

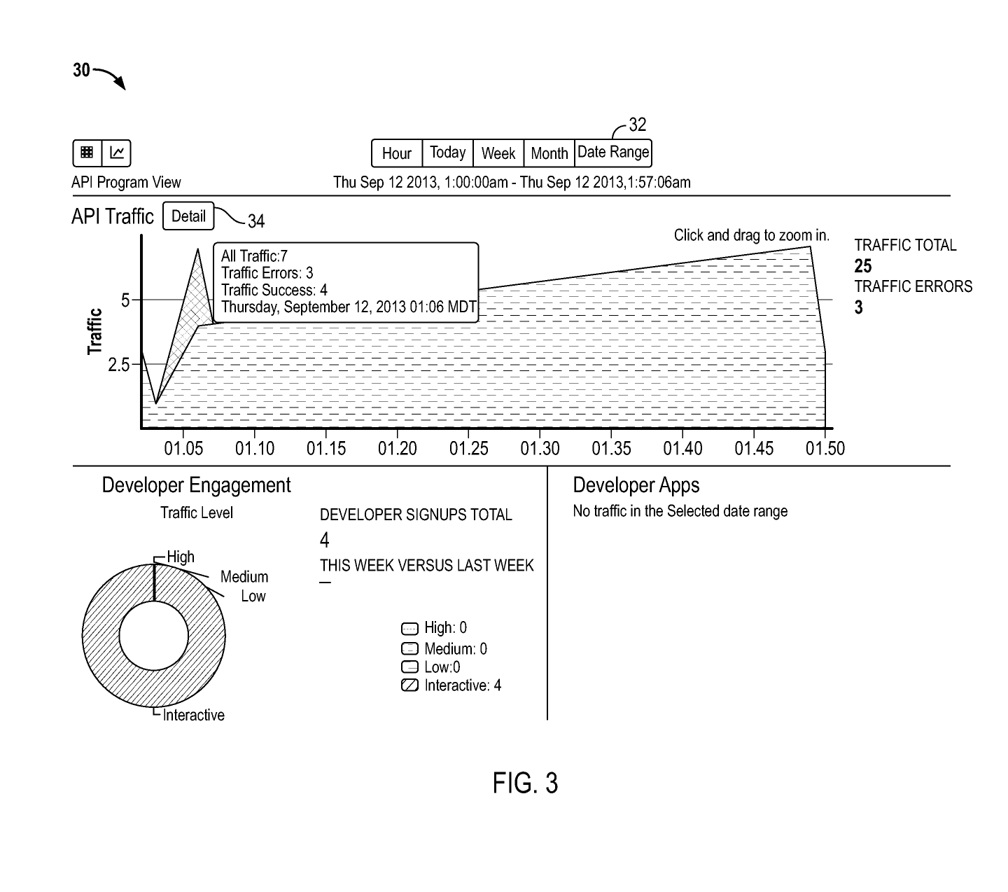

FIG. 3 illustrates a GUI 30 displaying API traffic information over a one hour period according to an illustrative embodiment of the invention. GUI 30 provides a high level view of the traffic, apps, products, and developers in API ecosystem 10. GUI 30 may display overall API calls for a particular time period and “environment” the user selects, displaying the number of successes and the number of errors as part of the total API traffic for ecosystem 10. An environment may be understood as a runtime execution context for API proxies. By default, an API Product Diagnostic may be deployed to an environment before the API is accessible over a network. Typically, organizations may be provisioned with two environments: ‘test’ and ‘prod’. The test environment may be used by developers for deploying API proxies during development. The ‘prod’ environment may be used by developers for promoting API proxies from test environment after they have been fully developed and tested. The GUI 30 may display information about developer signups and traffic, as well as traffic numbers for the top developer apps. The user may click on the Time Period icons 32 on a portion of GUI 30 to display data for the last hour, day, week or month, or select a custom date range from a calendar. In other embodiments, the user may also choose to aggregate the displayed data by minute, hour, day, week, or month and click over any point on the API traffic plot showing greater detailed API access information surrounding that point.

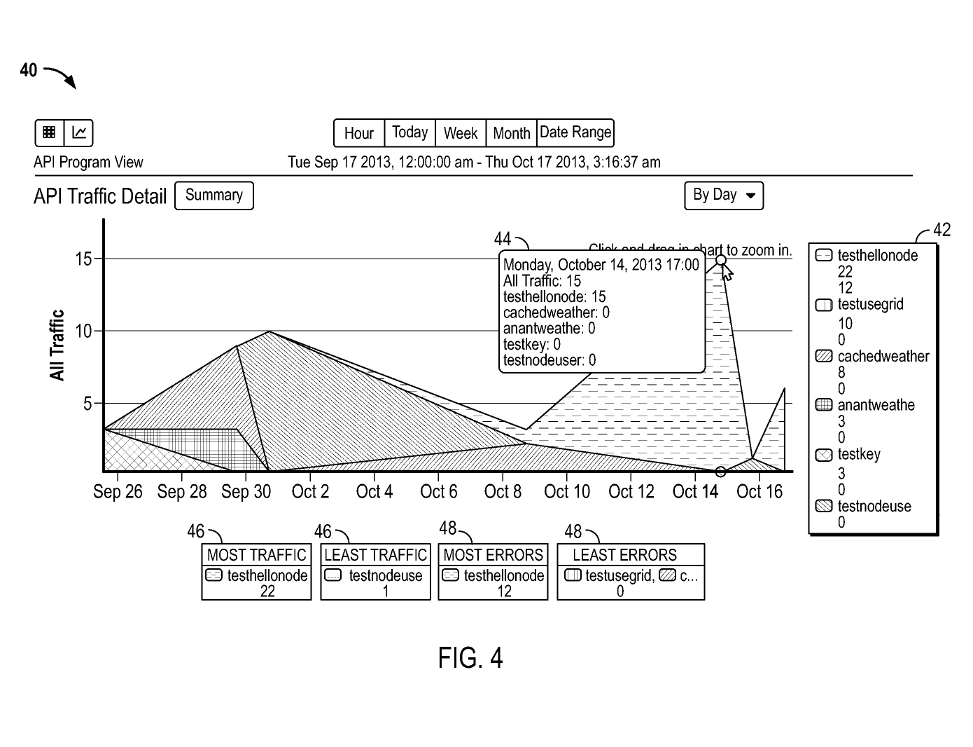

FIG. 4 shows a GUI 40 including an expanded detailed view of a plot of API traffic for a time period of ten days according to an illustrative embodiment of the invention. In certain embodiments, the user of GUI 30 may click on the detail tab 34 in API Traffic chart to toggle to a details window 40 to display data details for specific APIs 42. The user may also move a mouse pointer on GUI 40 over data points to activate a popup window 44 that displays details. A user may also zoom in on charts by clicking and dragging across chart areas. In addition, details window 40 may identify and list statistics for APIs that have the most and least traffic 46 and most and least errors 48 over a selected period.

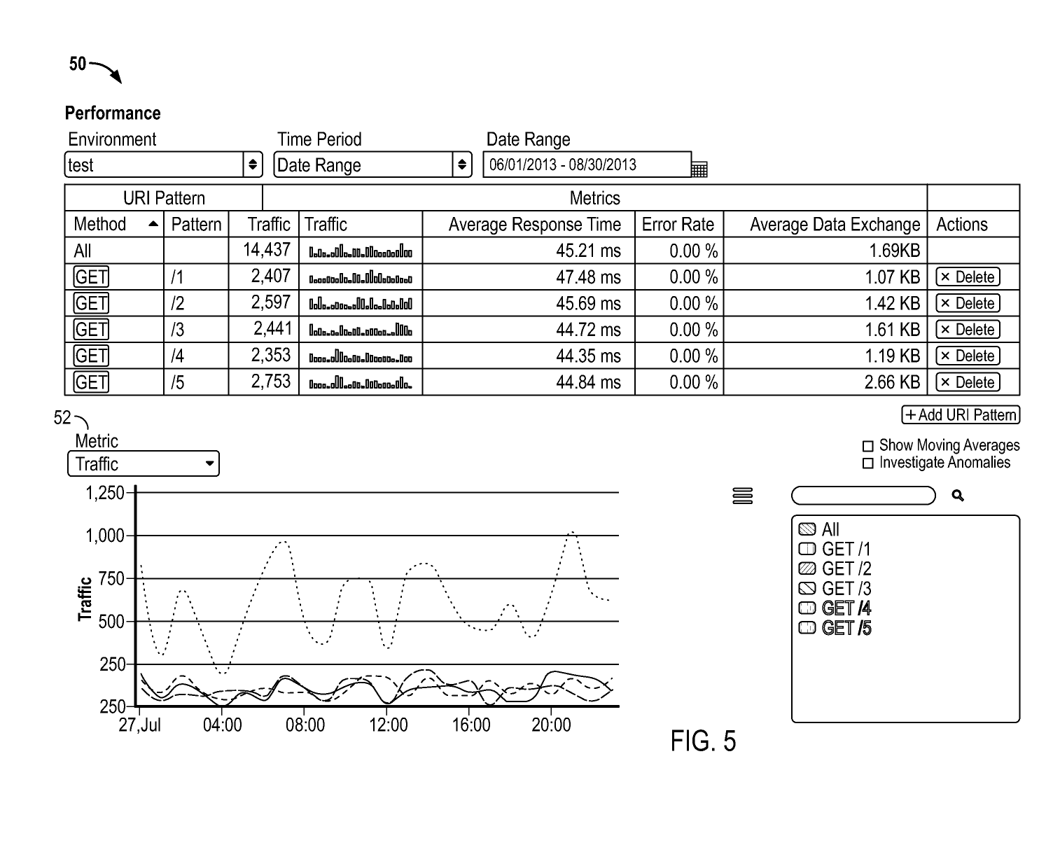

FIG. 5 shows a GUI 50 displaying performance metrics of resource paths for API Product Diagnostic 22. Various performance metrics may be available to monitor and display API performance and specifically anomalies in API traffic, including traffic, average response, average target response time, average endpoint response time, maximum response time, error rate and average data exchange. “Traffic” may be defined as throughput or the number of API requests and resulting responses over a period of time by system 10. The “average response time” may be defined as the time an API takes to respond to incoming requests. The “average target response time” may be defined as the time that elapses between a request to enter system 10 from diagnostic 22 to the response arrival at the Product Diagnostic 22 from system 10. The workflow for servicing of an API request may be as follows: 1) A request from an app is received by the diagnostic 22; 2) The request enters system 10, is processed, and then exits the diagnostic; 3) The request enters system 10 after exiting diagnostic 22; 4) The response from the system 10 is sent to the entity endpoint; 5) The response from the system 10 endpoint is sent to the diagnostic 22; 6) The response from the diagnostic 22 is sent to the external app. The average endpoint response time may be defined as the average time it takes the target endpoint to respond to an incoming request for the selected period. The maximum response time may be defined as the slowest response time for the selected period. The error rate may be the fraction of all API requests that are unsuccessful, that is, the request does not deliver a response as desired by the user. The average data exchange may be defined as the size of the request and response, i.e. the amount of data that is transferred in both directions as a request for an API service and a response generated and delivered to the calling entity.

A resource path may include a Universal Resource Identifier (URI) path fragment identifying an entity that developers can access by calling an API. For example, if the service backend provides weather reports and weather forecasts, the API might define two API resource paths as /reports and /forecasts. In other embodiments, system 10 provides the option for a developer to define API resource paths in the API Product Diagnostic 22, thereby obtaining the ability to apply management in a way that reflects the semantics of the particular API model, applying policies and scripted behavior to individual URIs and collecting fine-grained metrics for analytics services. In certain embodiments, the API resources may be hierarchical. For example, a Developer Services API may provide a method for listing all apps that belong to a developer with an URI path of /developers/{developer_email}/apps. The benefit of defining API resources provides app developers the ability to apply policies to requests that invoke those specific URIs, thereby providing specific control over the data and services that the API Product Diagnostic exposes. Additionally, system 10 may collect operation metrics specific to the API resources developer defines. By defining specific API resources, the developer may gain the visibility required to identify performance problems or error conditions as they affect specific calls against a particular API. Resources can be used to control access to specific assets or objects in an API. If the developer disables an API resource, or if she adds a security policy to it, she is effectively blocking the apps that call that resource.

FIG. 5 shows GUI 50 displaying the performance metrics for traffic, response time, error rate and average data exchange (response in KB) for resource paths GET/1, GET/2, GET/3, GET/4 and GET/5 of a selected API over a period of time according to one embodiment of the present invention. In the embodiment shown in FIG. 5A, GUI 50 may include a plot 52 that visually illustrates traffic trends or any of the other metrics above. This allows for multiple resources to be tracked for an API Product Diagnostic and the tracking of metrics on any and all of the resource paths to be compared on the GUI 50.

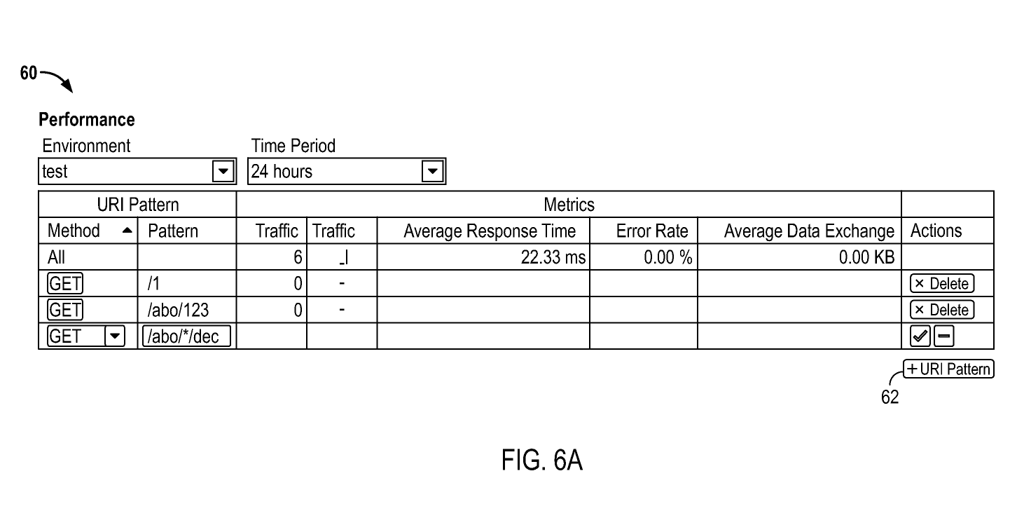

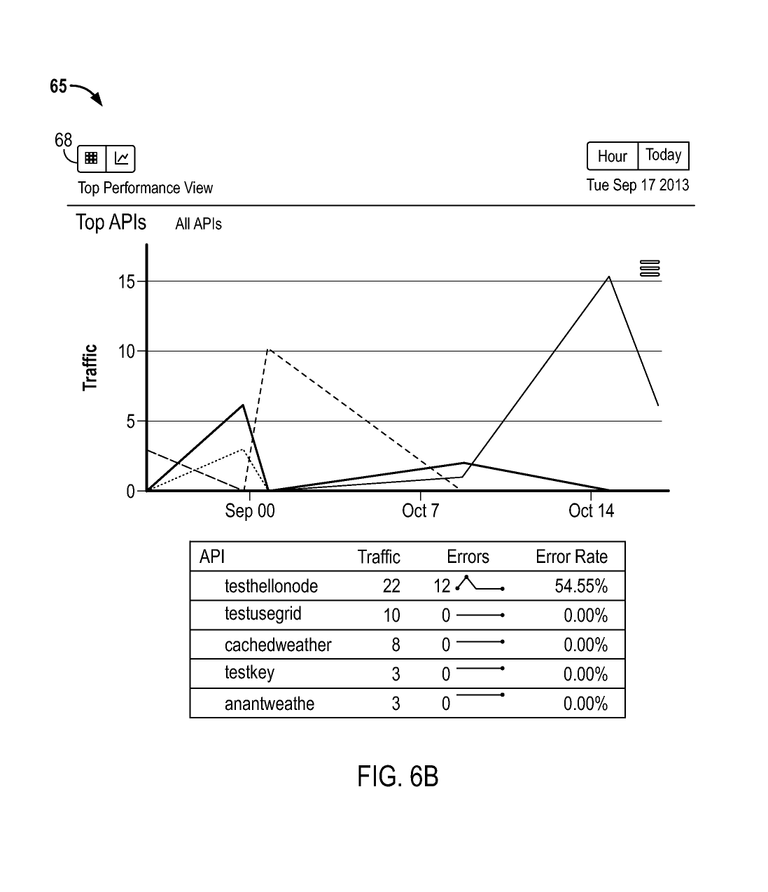

FIG. 6A shows a GUI 60 displaying user added performance metrics of resource paths in an API Product Diagnostic according to an illustrative embodiment of the invention. In order to add metrics for individual resources in an API Product Diagnostic, after selecting the API Product Diagnostic of interest, the user may click on +URI pattern icon 62 on the Performance section of GUI 60 then select the method/verb for each of the metrics of interest. The user may then enter a pattern for a URI that is beyond the default API Product Diagnostic base path. Patterns may begin with a forward slash and may include an asterisk (*) wildcard. For example, given a Product Diagnostic base path of /v1/inventory and resource paths of /1, /abc/123/dec, /abc/456/dec the user may collect metrics for /1 with /1, /abc/123 for /abc/123, and /abc/*/dec for the /abc/123/dec and /abc/456/dec URIs. After generating the user created URI patterns, the user may click on the check mark icon 64 to approve and make them available in the API ecosystem 10.

FIG. 6B shows a GUI 65 displaying APIs with the highest traffic over a selected time period of time (“Top APIs” metric) according to an illustrative embodiment of the invention. A user may click on the “Top Performance View” 68 to activate a window such as GUI 65 for showing charts for one or more performance metrics. Besides the “Top APIs” metric as shown in FIG. 6B, GUI 65 may also display charts for API metrics pertaining to “Top Developer Apps,” “Top Developers,” and “Top Products.” Top Developer Apps may include developer apps with the highest traffic over the selected time period. Top Products may include API products with the highest traffic over the selected time period. API products may be groups or collections of APIs that are logically grouped into sets for the purposes of provisioning access, logging or metrics generation with the ability to view and maintain control at the group level. Top Developers may include developers with the highest traffic over the selected time period. Displaying such performance metrics gives API developers and providers further insight into traffic, response time, and errors per API.

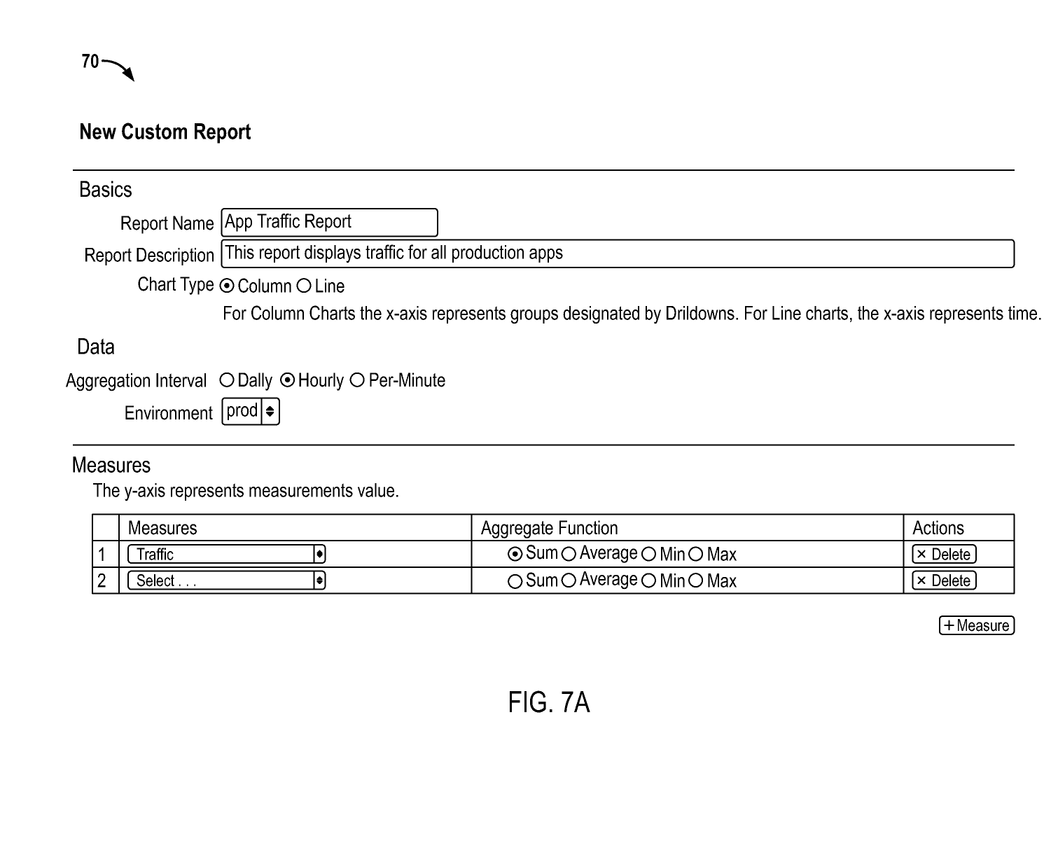

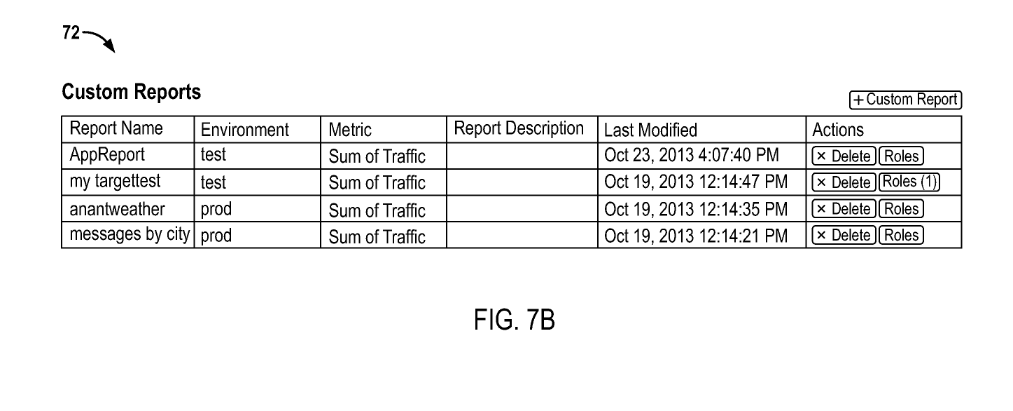

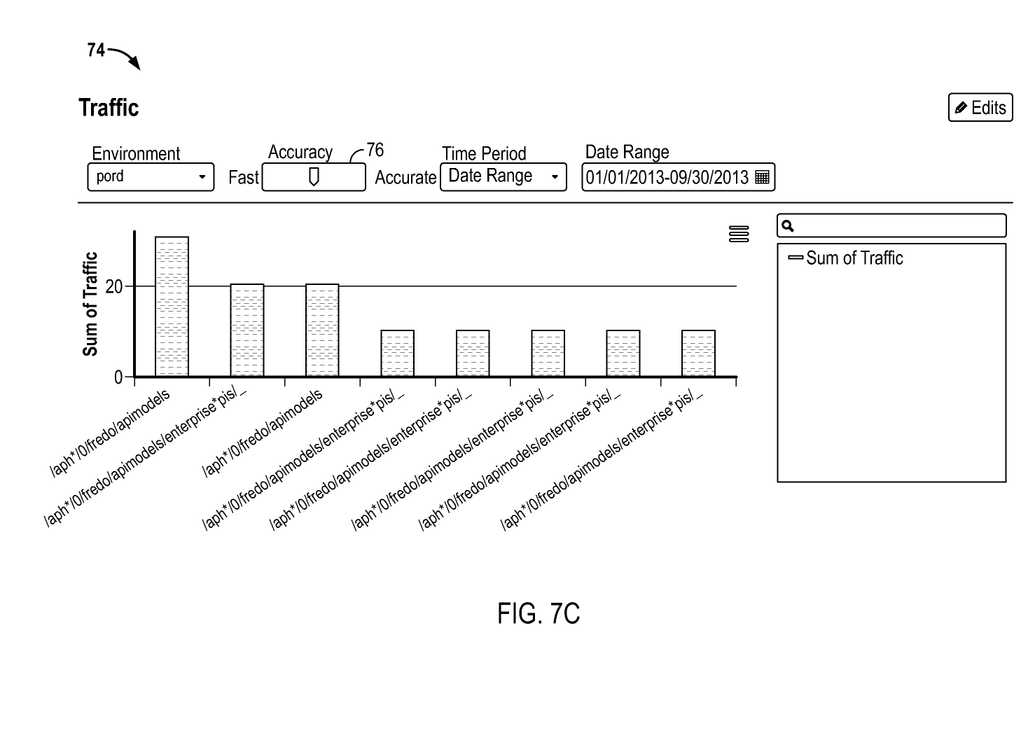

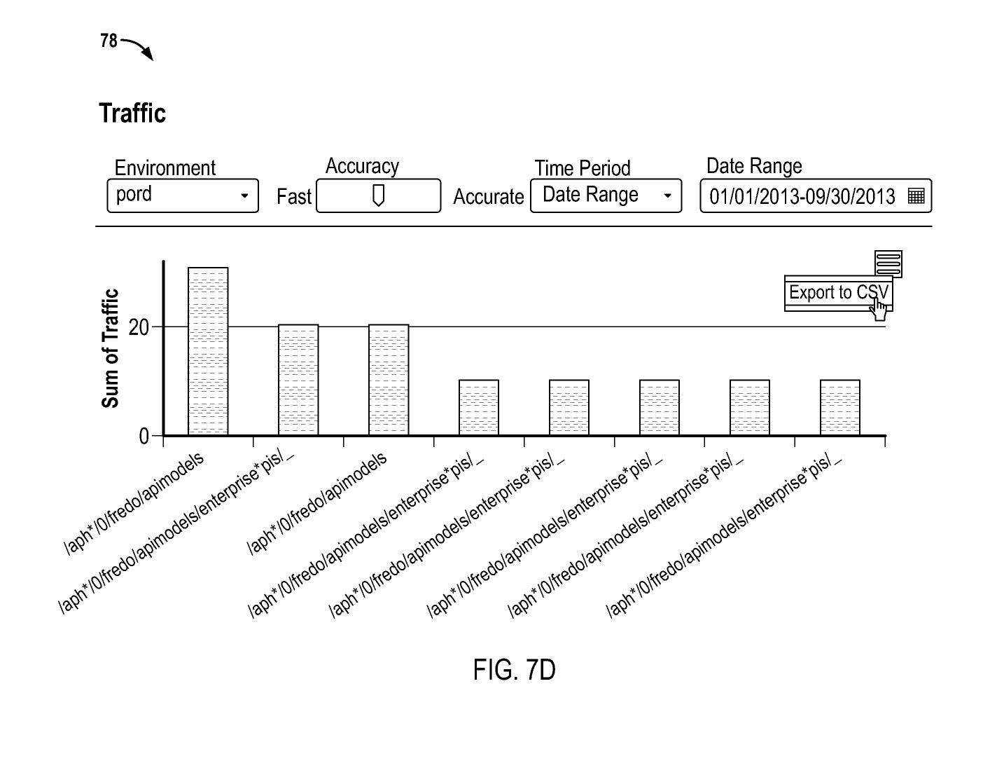

FIG. 7A illustrates a GUI 70 for building a custom report to receive statistics of API traffic based on user preferences according to one embodiment of the present invention. As data passes through system 10, diagnostic 22 collects information about the traffic and stores it as measures and dimensions. By combining measures, dimensions, and filters, the user can create reports regulating what data is being displayed.

Measures may be numeric representations of a set of activities that have occurred. For example a “message count” measure may show the message count for one or more APIs, an “error” measure may pinpoint the APIs that are causing issues with the server, and a “total response time” measure may help the user visualize how the server is performing. Dimensions may be categories of information that are used to group data. Users may view measures by dimensions. Dimensions may be stacked to create drilldowns, meaning the user may select a top-level dimension and then each successive dimension further refines the data to focus in on a smaller and smaller subset of data. Filters allow the user the further refine reports by including or excluding data based on expressions.

In order to generate a custom report as shown in FIG. 7A, the user may wish to input certain information which will be analyzed and reported to the user by system 10. The user may input a report name and description of the report and also select a chart type, column or line and select a data aggregation interval for the report (e.g. hourly may show data aggregated every hour, daily may show data aggregated every 24 hours, per minute may show data aggregated every minute). In addition, the user may select an environment from which the data is be collected and in the measures section, choose data for a first metric (such as traffic as shown in FIG. 7A) that the user wishes to present in the report and select an aggregation function that can be applied to the data for the first metric. For example, the user may select an aggregation function to display the sum, average, minimum value or maximum value. In other embodiments, the user may further narrow the data displayed by adding filters to the report definition. The user may select an entity to filter on, and construct an expression with the Operator and Value to include or exclude data in the report. For example, the user could add a filter that excludes data for a weather API Product Diagnostic or a specific developer.

FIG. 7B illustrates a GUI 72 showing a generated custom report of API traffic based on user inputted metrics according to an illustrative embodiment of the invention. GUI 72 lists all the available custom reports generated by the user and lists the following elements: Report Name (name of the report), Environment (the runtime execution context which data was collected), Metric (the primary measure specified in the report), Report Description (the description of the Report as previously inputted by the user), and Last modified (the date and time when the report was last modified).

FIG. 7C illustrates a GUI 74 showing a generated custom bar graph for a plurality of resource paths based on user inputted metrics according to an illustrative embodiment of the invention. In certain embodiments, a user may click on a portion of the Report Name of interest on Custom Reports GUI 72 to activate window 74. The accuracy slider 76 allows the user to trade off performance versus accuracy in the report. A user may mouse the slider over to the right to a “Fast” setting producing fastest results but a smaller sample size of traffic to produce the report. The user may slide the slider to the “Accurate” setting and a larger sample size is used wherein the results will not be produced as quickly as for the “Fast” setting, but due to a larger sample size the results will be more accurate.

FIG. 7D illustrates a GUI 76 displaying a user selected option of exporting a saved custom report to CSV, PDF or PNG format according to an illustrative embodiment of the invention.

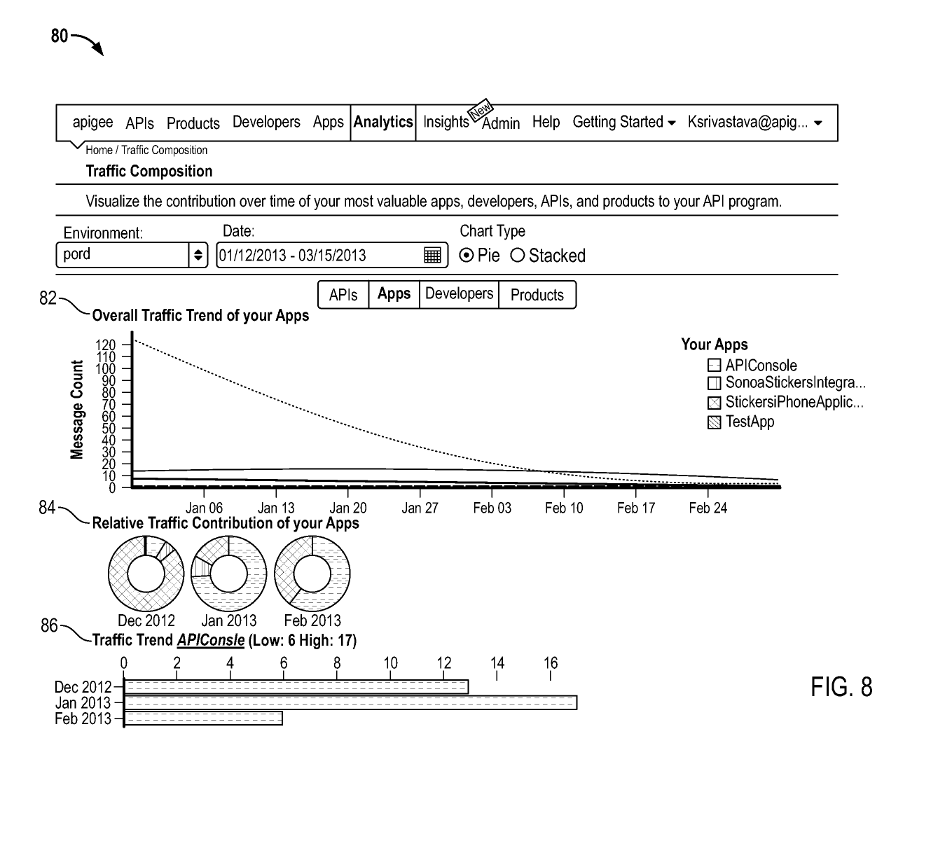

FIG. 8 illustrates a GUI 80 displaying a Traffic Composition Report for monitoring the contribution of entities to API traffic with relative traffic contribution displayed via a circle graph according to an illustrative embodiment of the invention. The Traffic Composition Report provides insights regarding the most value entities of an API ecosystem: e.g. apps, developers, APIs, resources, etc. by enabling users of the UI to visualize trends of the contribution of these entities to API traffic. To view the Traffic Composition Report, the user may click on a Traffic Composition option on the Analytics tab of GUI 80 and choose the type of entity (e.g. APIs, apps, developers, products) for the report.

For each entity type, the report displays the following charts: Overall Traffic Trends, Relative Traffic Contribution, and Traffic Trend for the Entity. Overall Traffic Trends may plot the number of messages for each entity of the selected type over time—for example, the number of messages for each API over time. Relative Traffic Contribution may plot the relative amount of traffic contributed by each entity of the selected type over time—for example, the relative contribution of each app over time. Traffic Trend for the Entity may allow the user to mouse over and click a segment of the Relative Traffic Contribution chart to view the traffic trend for the corresponding entity. For example, the user may click on a segment that displays the relative traffic contribution for a specific developer to view the traffic trend for that developer. GUI 80 of FIG. 8 displays Overall Traffic Trends 82, Relative Traffic Contribution 84 and Traffic Trend 86 for User's selected Apps according to one illustrative embodiment of the invention.

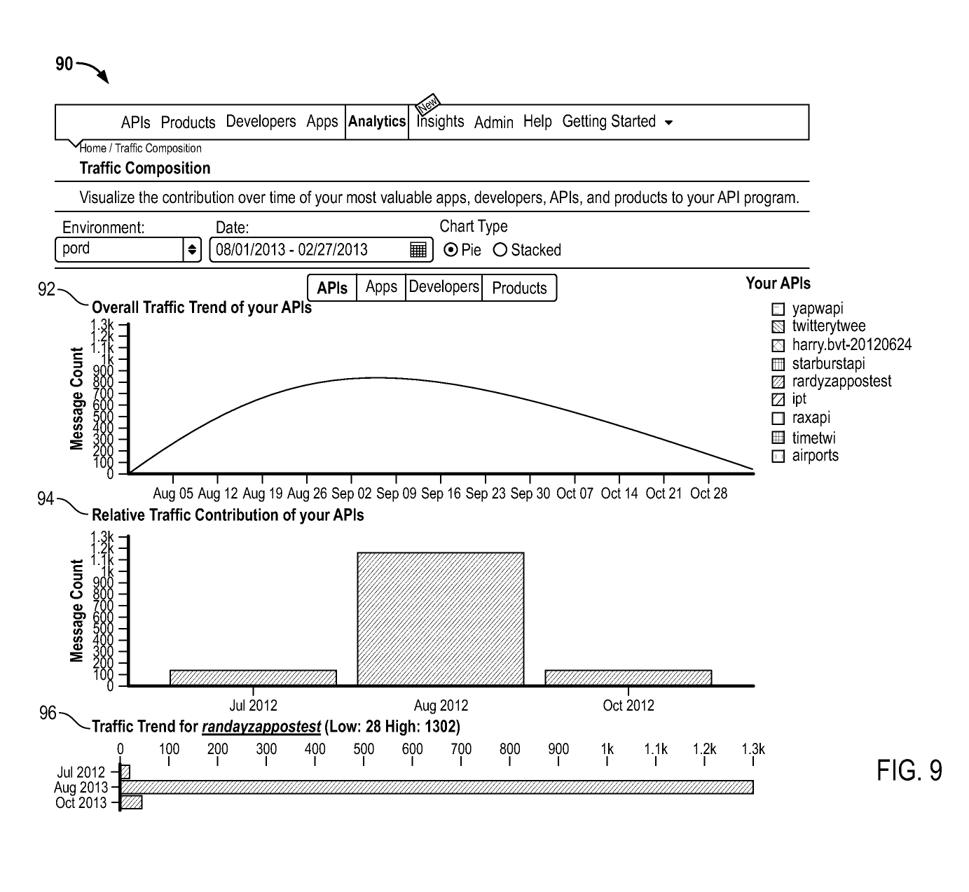

FIG. 9 illustrates a GUI 90 displaying a Traffic Composition Report for monitoring the contribution of entities to API traffic with relative traffic contribution displayed via a bar graph according to an illustrative embodiment of the invention. GUI 90 of FIG. 9 displays Overall Traffic Trends 92, Relative Traffic Contribution 94 and Traffic Trend 96 for User's selected APIs according to one illustrative embodiment of the invention.

Developers and service providers may use the Traffic Composition Report to detect business problems such as lower traffic trends or diminishing contribution from key apps and/or developers. Such visibility may help users determine the apps or developers that had once contributed substantially to a particular API, but are no longer contributing as much. The Traffic Reports may also provide developers and service providers early notification of entities that contribute to API traffic, thereby providing them with information about new entities that may require further cultivation. Lastly, Traffic Composition Reports provide strategic and tactical insight for capacity planning of API traffic by giving visibility of those entities that have a sustained contribution to the API ecosystem including relative contribution of those entities over time.

While exemplary embodiments of the invention have been described in connection with various computing devices and network architectures, the underlying concepts may be applied to any computing device or system in which it is desirable to implement a method for collecting and reporting API performance entities. Thus, the methods and systems described in connection with embodiments of the present invention may be applied to a variety of applications and devices. While exemplary programming languages, names and examples are chosen herein as representative of various choices, these languages, names and examples are not intended to be limiting. One of ordinary skill in the art will appreciate that there are numerous ways of providing object code that achieves the same, similar or equivalent systems and methods achieved by embodiments of the invention.

The various techniques described herein may be implemented in connection with hardware or software or, where appropriate, with a combination of both. Thus, the methods and apparatus of the invention, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. While aspects of the present invention has been described in connection with the preferred embodiments of the various figures, it is to be understood that other similar embodiments may be used or modifications and additions may be made to the described embodiment for performing the same function of the present invention without deviating therefrom. Furthermore, it should be emphasized that a variety of computer platforms, including handheld device operating systems and other application specific operating systems are contemplated, especially as the number of wireless networked devices continues to proliferate. Therefore, the claimed invention should not be limited to any single embodiment, but rather should be construed in breadth and scope in accordance with the appended claims.

What is claimed is:

1. A method for monitoring and reporting data of one or more application programmer interface (API) entities comprising:
receiving a request for usage data of one or more API entities;
monitoring said usage data from at least one server; and
displaying information pertaining to said monitored usage data.

2. The method of claim 1, wherein the displaying includes displaying information on a graphical user interface (GUI).

3. The method of claim 1, wherein the monitoring includes monitoring a number of API requests over a particular time for one or more API entities.

4. The method of claim 1, further comprising determining performance metrics for one or more API entities including at least one of average response time, average target response time, error rate, and average data exchange.

5. The method of claim 1, wherein the displayed information identifies at least one usage trend of said one or more API entities.

6. The method of claim 1, wherein the displaying includes displaying information pertaining to one or more resource paths for at least one API entity.

7. The method of claim 1, further comprising generating a custom report about said one or more API entities based upon user input and displaying said custom report.

8. The method of claim 1, further comprising determining the contribution of one or more monitored API entities to total monitored usage data and displaying said information pertaining to said determination.

9. The method of claim 1, further comprising analyzing one or more trends of said usage data and displaying information pertaining to said analysis.

10. The method of claim 9, wherein the analysis of one or more trends includes analyzing at least one of overall traffic trends for API entities, relative traffic contribution for one or more API entities, and traffic trends for a specific API entity.

11. An application program interface (API) analytics system for monitoring and reporting data of one or more application programmer interface (API) entities comprising:
an API diagnostic receiving a request for usage data of one or more API entities;
a processor monitoring said usage data from at least one server; and
a display unit displaying information pertaining to said monitored usage data.

12. The system of claim 11, wherein the display unit displays information on a graphical user interface (GUI).

13. The system of claim 11, wherein the processor monitors a number of API requests over a particular time for one or more API entities.

14. The system of claim 11, wherein the processor further determines performance metrics for one or more API entities including at least one of average response time, average target response time, error rate, and average data exchange.

15. The system of claim 11, wherein the displayed information identifies at least one usage trend of said one or more API entities.

16. The system of claim 11, wherein the display unit further displays information pertaining to one or more resource paths for at least one API entity.

17. The system of claim 11, wherein the processor generates a custom report about said one or more API entities based upon user input and displaying said custom report.

18. The system of claim 11, wherein the processor determines the contribution of one or more monitored API entities to total monitored usage data and displaying said information pertaining to said determination.

19. The system of claim 11, wherein the processor analyzes one or more trends of said usage data and displaying information pertaining to said analysis.

20. The system of claim 19, wherein the analysis of one or more trends includes analyzing at least one of overall traffic trends for API entities, relative traffic contribution for one or more API entities, and traffic trends for a specific API entity.
